(19) United States
(12) Patent Application Publication
(10) Pub. No.: US 2011/0001712 A1
(43) Pub. Date: Jan. 6, 2011

(54) DISPLAY DEVICE

(75) Inventor: Yoshihiro Saito, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/781,167

(22) Filed: May 17, 2010

(30) Foreign Application Priority Data
Jul. 1, 2009 (JP) 2009-157042

(51) Int. Cl. G06F 3/041; G06F 1/16

(52) U.S. Cl. 345/173; 361/679.21

(57) ABSTRACT

On a circumferential edge part of a display panel having a display surface, a front bezel having an aperture through which a cleaning member for removing dust adhering to the display surface can be freely inserted and removed is provided. Moreover, a touch panel is provided on the front bezel in such a manner that the touch panel is arranged to face the display surface of the display panel with a gap formed between the display surface and the touch panel.

### CROSS-REFERENCE TO RELATED APPLICATION

This application is based upon and claims the benefit of priority from the prior Japanese Patent Application No. 2009-157042, filed Jul. 1, 2009, the entire contents of which are incorporated herein by reference.

### TECHNICAL FIELD

The present invention relates to a display device having a touch panel provided on the surface of an LCD (liquid crystal display).

### BACKGROUND

Recently, electronic apparatuses having a display device having a touch panel provided on the surface of an LCD panel or the like are broadly used.

However, a display device provided in an apparatus used by an unspecified large number of people, such as an automated teller machine installed in banks or public facilities, has a problem that its touch surface becomes gradually stained and unhygienic through the use.

As a conventional technique to address this problem, for example, an input, device disclosed in JP-A-8-185560 is known. In this input device, a protective sheet is spread to cover the touch surface of the touch panel, and when power is turned on, the sheet is wound by a motor so that an unused part of the sheet faces the touch surface. This configuration aims for keeping the projective sheet covering the touch surface clean and hygienic.

Normally, the touch panel is attached with a predetermined gap from the LCD panel, with a front bezel provided between the touch panel and the LCD panel. The purpose of providing the front bezel and thus providing the gap is to prevent inconvenience such as temporary change of color on the display surface due to the application of a pressure to the LCD panel when the touch panel is operated by touch.

However, the formation of this gap generates a problem that dust that enters the inside of the display device from a connecting part or the like of the casing of the display device then enters the gap and adheres to the display surface, lowering the visibility of the screen or giving the user an uncomfortable impression.

For example, a display device provided in an apparatus that is essential for accomplishing business operations, for example, a POS (point of sale) terminal used for accounting in each store or the like, is used for a long time and therefore dust tends to enter the device as described above. However, since the display device must be disassembled in order to remove the dust, users find it difficult to cope with the dust by themselves and need to have a maintenance worker who is dispatched from a maintenance service company disassemble the display device and remove the dust. With such a measure, the POS terminal is temporarily unavailable for use, which might cause trouble in business operations. Since this problem is related to the one surface on the display panel side of the touch panel, it is difficult to apply the technique disclosed in JP-A-8-185560, which aims for maintaining a preferable hygienic condition on the touch surface side of the touch panel.

### SUMMARY

In view of the foregoing circumstance, an object of the invention is to provide a display device in which dust entering a gap provided between a display surface and a touch panel can be removed easily and quickly.

According to an aspect of the invention, a display device includes: a display panel having a display surface; a front bezel provided on a circumferential edge part of the display panel and having an aperture through which a cleaning member for removing dust adhering to the display surface can be freely inserted and removed; and a touch panel provided on the front bezel in a manner that the touch panel is arranged to face the display surface of the display panel, with a gap formed between the display surface of the display panel and the touch panel.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic perspective view of a POS terminal having a display device according to a first embodiment.

FIG. 2 is an exploded perspective view of the display device according to the first embodiment.

FIG. 3 is an A-A sectional view of the display device according to the first embodiment.

FIG. 4 is a B-B sectional view of the display device according to the first embodiment.

FIG. 5 is a view for explaining the insertion and removal of a cleaning sheet to and from the display device according to the first embodiment.

FIG. 6 is a view for explaining the insertion and removal of the cleaning sheet to and from the display device according to the first embodiment.

FIG. 7 is an exploded perspective view of a display device according to a second embodiment.

### DETAILED DESCRIPTION

### First Embodiment

Hereinafter, a first embodiment will be described with reference to the drawings.

In this embodiment, a display device provided in a POS terminal 1 used for accounting in various kinds of commodity sales shops is described as an example.

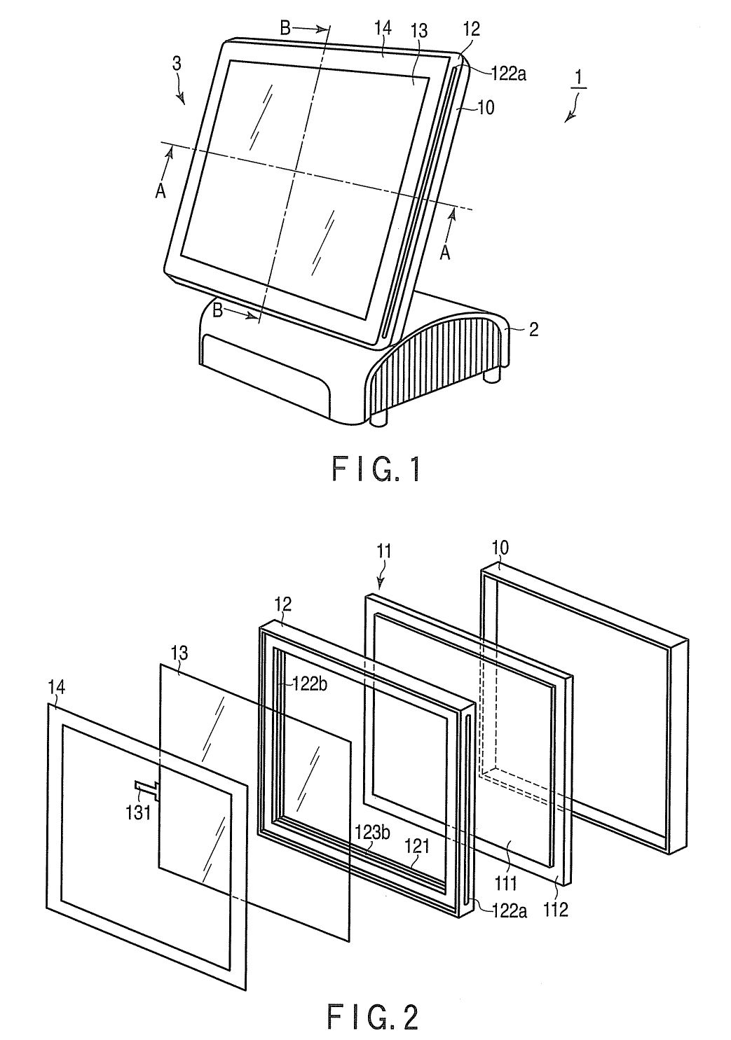

The configuration of the POS terminal 1 will be described with reference to FIG. 1 to FIG. 4.

FIG. 1 is a perspective view showing the appearance of the POS terminal 1. The POS terminal 1 includes a base unit 2 and a display device 3. The base unit 2 is equipped with a CPU (central processing unit) which functions as a control center, a ROM (read only memory) in which fixed data is stored, a RAM (random access memory) which forms various work memory areas, a controller for various devices provided in the POS terminal 1, and so on.

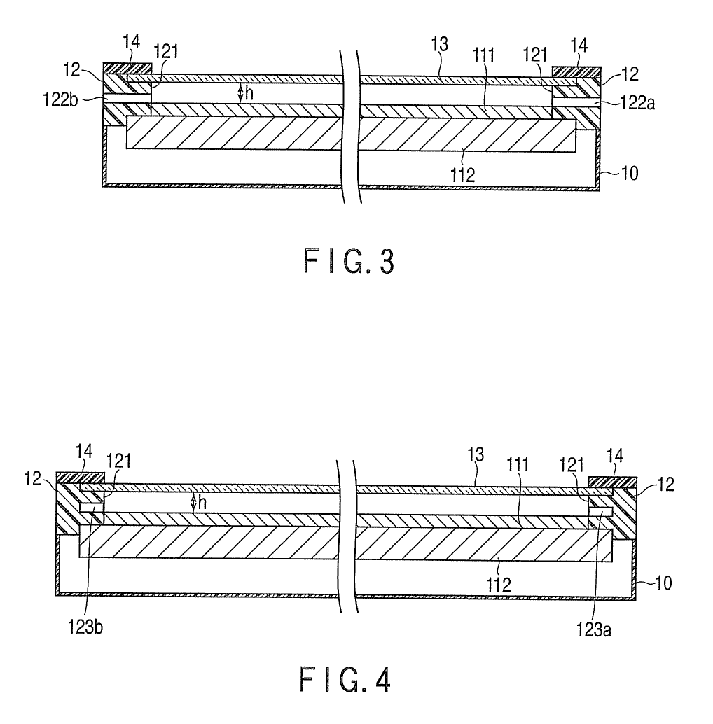

FIG. 2 is an exploded perspective view showing the structure of the display device 3. FIG. 3 is a sectional view showing the A-A cross section of the display device 3 shown in FIG. 1. FIG. 4 is a sectional view showing the B-B cross section of the display device 3 shown in FIG. 1. The display device 3 includes a back cover 10 having a circuit board (not shown), a substantially rectangular flat LCD panel 11 including a display unit 111 and a backlight system 112, a substantially rectangular frame-like front bezel 12 provided on the circumferential edge part of the LCD panel 11, a substantially rectangular flat touch panel 13 provided on the front bezel 12 in such a manner that the touch panel 13 is arranged to face the display unit 111 (display surface) of the LCD panel 11, and a substantially rectangular frame-like front cover 14 having an aperture of substantially the same shape as the display unit 111 of the LCD panel 11.

The back cover 10 is electrically connected with a control circuit of the based unit 2 via a communication line and has a display control circuit (not shown) which controls screen display on the display unit 111 and a touch panel control circuit (not shown) which detects a touch operation on the touch panel 13 and takes in a signal indicating the position of the operation.

The LCD panel 11 is electrically connected with the display control circuit of the back cover 10 via a flexible printed circuit board. The display control circuit supplies an image signal to the LCD panel 11 via the flexible printed circuit board and thus cases the display unit 111 to display an image.

The touch panel 13 employs, for example, a resistive film type. Two transparent conductive films are arranged with a very small gap and a protective film made of a light-transmitting member is fixed to the surface of the transparent conductive film on the operation side. In the touch panel 13 having this configuration, a signal corresponding to a voltage change that is generated when the two transparent conductive films are brought in contact with each other by a touch operation from above the protective film is outputted from an output terminal 131 provided on a lateral side. The terminal 131 is electrically connected with the touch panel control circuit of the back cover 10 via a flexible cable. The touch panel control circuit calculates the coordinates of the touch position based on the signal outputted from the output terminal 131.

The front bezel 12 has a convex guide 121 formed on the entire inner circumferential surface, as shown in FIG. 2 to FIG. 4. On the sidewalls on the left and right sides of the front bezel 12, substantially linear apertures 122a and 122b are provided penetrating the guide 121 up to the convex surfaces of the guide 121. On the convex surfaces of the guide 121 on the inner walls on the top and bottom sides of the front bezel 12, substantially linear grooves 123a and 123b are provided having a depth that is flush with both ends in the longitudinal direction of the apertures 122a and 122b.

The apertures 122a and 122b are provided linearly with a greater length than the width of the display unit 111 in substantially the same direction as the longitudinal direction of the apertures 122a and 122b. The purpose of this arrangement is to enable cleaning on the entire surface of the display unit 111 with a cleaning sheet 30, which will be described later.

As shown in FIG. 3 and FIG. 4, the display unit 111 side of the LCD panel 11 is fitted with one surface of the guide 121 of the front bezel 12 as the sidewalls of the display unit 111 are abutted against the inner circumferential surface of the guide 121. As the front bezel 12 is attached to the back cover 10 in the state where the sidewalls are fitted with the one surface of the guide 121, the circumferential edge of the LCD panel 11 is inserted between the back cover 10 and the front bezel 12 and thus held.

Moreover, as the touch panel 13 is fitted with one surface of the guide 121 of the front bezel 12 and the front cover 14 is attached to the front bezel 12, the circumferential edge of the touch panel 13 is inserted between the front cover 14 and the front bezel 12 and thus held.

Thus, the back cover 10, the LCD panel 11, the front bezel 12, the touch panel 13 and the front cover 14 are integrated and form the display device 3.

Since the front bezel 12 is thus sandwiched between the LCD panel 11 and the touch panel 13, a gap h indicated by the arrow in FIG. 3 and FIG. 4 is formed between the LCD panel 11 and the touch panel 13. As this gap h is formed, the display unit 111 of the LCD panel 11 does not receive pressure when the user touches and operates the touch panel 13. Thus, preferable visibility of the image displayed on the display unit 111 is maintained.

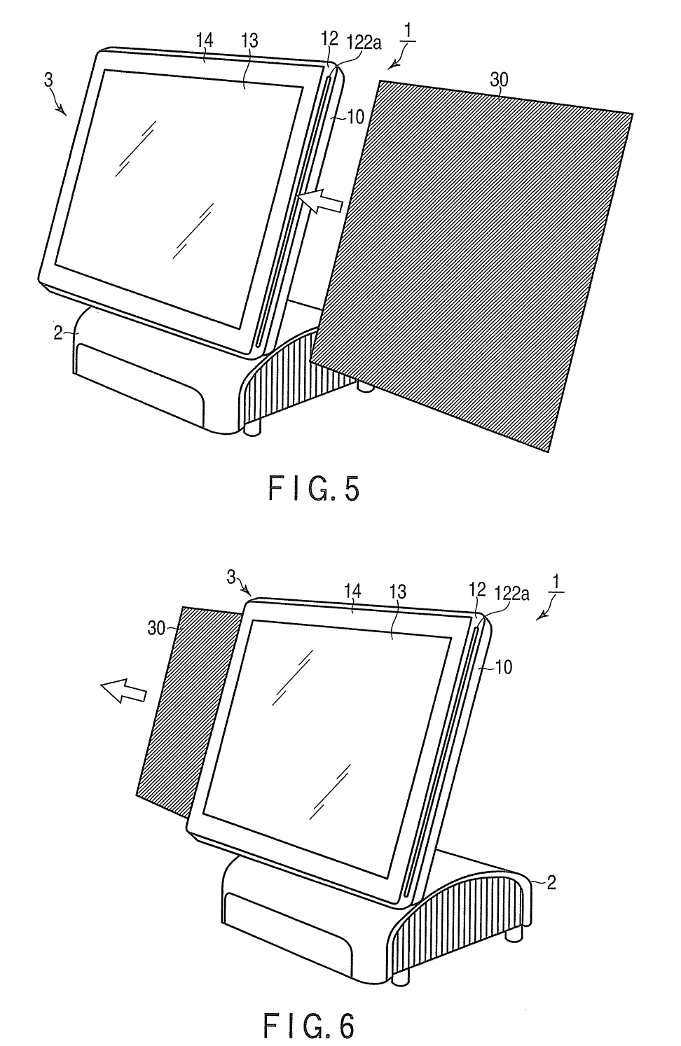

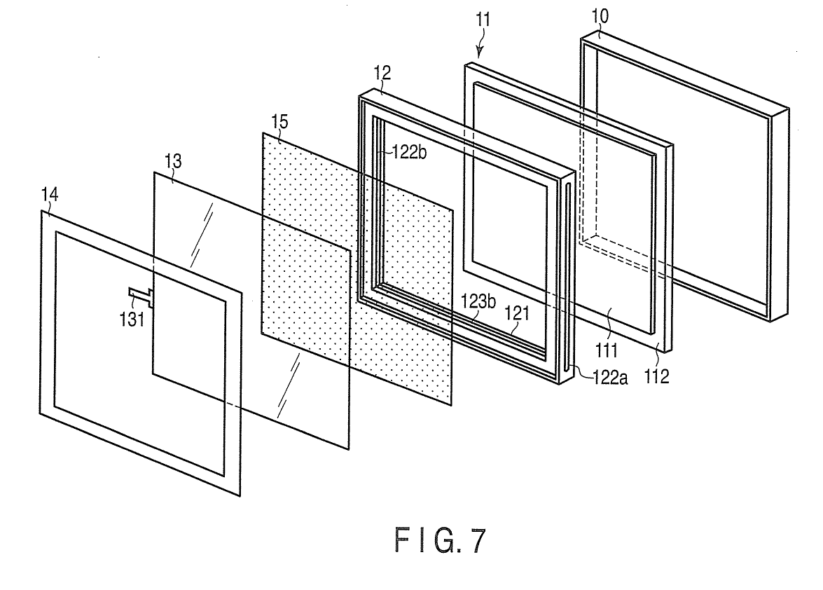

Next, a technique of removing dust adhering to the display unit 111 of the LCD panel 11 will be described with reference to FIG. 4 and the perspective view of the appearance of the POS terminal 1 shown in FIG. 5.

In a shop where the POS terminal 1 is installed, the substantially rectangular flat cleaning sheet 30 made of a fiber material such as felt is prepared. The width of the cleaning sheet 30 in the direction of insertion to the apertures 122a and 122b is made greater than the width between the left and right sidewalls of the front bezel 12 where the apertures 122a and 122b are provided. The width of the cleaning sheet 30 in the direction substantially orthogonal to the direction of insertion is made smaller than the width in the longitudinal direction of the apertures 122a and 122b and greater than the width between the convex surfaces of the guides 121 provided on the inner walls on the top and bottom sides of the front bezel 12. Moreover, the thickness of the cleaning sheet 30 is made slightly smaller than the width in the short-side direction of the apertures 122a and 122b. Because of such a shape, the cleaning sheet 30 can be freely inserted into and removed from the apertures 122a and 122b.

The cleaning sheet 30 inserted from one of the apertures 122a and 122b is guided to the other aperture by the grooves 123a and 123b provided on the inner walls on the top and bottom sides of the front bezel 12. Eventually, before the rear edge of the cleaning sheet 30 inserted from one of the apertures 122a and 122b reaches the one aperture, the forward edge protrudes from the other aperture. At this time, if the forward edge of the cleaning sheet 30 protruding from the other aperture is nipped and pulled, the cleaning sheet 30 can be extracted from within the display device 3.

When the cleaning sheet 30 is inserted into and removed from the apertures 122a and 122b, one surface of the cleaning sheet 30 and the display unit 111 of the LCD panel 11 slide in contact with each other and therefore dust adhering to the display unit 111 is caught by the cleaning sheet 30. Then, when the cleaning sheet 30 is extracted from the display device 3, the dust is pushed out of the display device 3 by the sheet 30. As this work is carried out, the dust within the gap h can be removed from within the display device 3.

As described above, in the display device 3 according to this embodiment, the pair of apertures 122a and 122b continuing to the gap h formed between the LCD panel 11 and the touch panel 13 is provided on the sidewalls on the left and right sides of the front bezel 12. As the cleaning sheet 30 is inserted into and removed from these apertures 122a and 122b, dust adhering to the display unit 111 can be removed. This work is so simple that it is not necessary to have a maintenance worker do the work. A user such as a shop assistant can do this work easily and quickly.

The apertures 122a and 122b are provided substantially linearly with a greater length than that of the display unit 111 of the LCD panel 11. Therefore, the entire surface of the display unit 111 can be cleaned with the cleaning sheet 30.

The apertures 122a and 122b are provided on the sidewalls on the left and right sides of the front bezel 12. Therefore, since the cleaning sheet 30 inserted from one of the apertures 122a and 122b can be extracted from the other, the cleaning sheet 30 can sufficiently slide in contact with the entire surface of the display unit 111.

In the guides 121 provided on the inner walls on the top and bottom sides of the front bezel 12, the grooves 123a and 123b to guide the cleaning sheet 30 are provided. Therefore, the cleaning sheet 30 inserted from one of the apertures 122a and 122b is guided by the grooves 123a and 123b and securely reaches the other aperture while sliding in contact with the display unit 111. Thus, it can be said that the cleaning sheet 30 can efficiently slide in contact with the display unit 111 when the cleaning sheet 30 is inserted and removed.

### Second Embodiment

Next, a second embodiment will be described with reference to FIG. 7.

This embodiment differs from the first embodiment in that a privacy filter to prevent peeping is attached to the display device 3. The same parts as in the first embodiment are denoted by the same reference numerals and will not be described further in detail.

FIG. 7 is an exploded perspective view of the display device 3. The display device 3 according to this embodiment has a substantially rectangular flat privacy film 15 having a size large enough to cover the entire display unit 111, between the LCD panel 11 and the touch panel 13.

The privacy film 15 includes, for example, a louver layer sandwiched between substantially transparent face-side base and back-side base. The louver layer has plural small louvers. These small louvers act to limit the traveling direction of transmitted light within a predetermined range of light-exiting angle. Each of the small louvers is arranged to extend parallel to the surface of the louver layer and parallel to each other with predetermined spacing.

A substantially transparent adhesive layer is formed on one surface of the privacy film 15. The privacy film 15 is fixed to the touch panel 13 as the one surface where the adhesive layer is formed is bonded to the back side of the touch panel 13. As described in the first embodiment, the touch panel 13 with the privacy film 15 bonded thereto is sandwiched between the front bezel 12 and the front cover 14 and thus fixed.

If the display device 3 additionally includes the privacy film 15 in this manner, the gap h is formed between the display unit 111 of the LCD panel 11 and the privacy film 15 bonded to the touch panel 13. Therefore, dust may enter the gap h and adhere to the display unit 111, thus lowering visibility.

Thus, if the cleaning sheet 30 is inserted into and removed from one of the apertures 122a and 122b in order to remove the dust adhering to the display unit 111, the sheet 30 is guided by the grooves 123a and 123b and reaches the other aperture while sliding in contact with the display unit 111. Thus, the sheet 30 pushes the dust out of the display device 3.

In this manner, in the display device 3 according to this embodiment, the privacy film 15 is arranged between the LCD panel 11 and the touch panel 13. Also in this case, if the cleaning sheet 30 is inserted into and removed from the apertures 122a and 122b, the dust that enters the gap h formed between the display unit 111 and the privacy film 15 can be removed.

Additionally, similar advantages to those of the first embodiment can be achieved as a matter of course.

### Modification

In the embodiments, the display device provided in the POS terminal is described as an example. However, the configurations disclosed in the embodiments may also be applied to a display device provided in other electronic apparatuses or a display device used by being connected to other electronic apparatuses.

In the embodiments, the case where the pair of apertures 122a and 122b is provided on the sidewalls on the left and right sides of the front bezel 12 is described. However, the position where apertures for inserting and removing the cleaning sheet 30 are provided is not limited to the position in the embodiments. Moreover, a pair of apertures may be provided on the sidewalls on the top and bottom sides of the front bezel 12.

As for the apertures for inserting and removing the cleaning sheet 30, it is possible to provide only one aperture on the sidewall on one side of the front bezel 12 instead of a pair of apertures. Even in this case, if the cleaning sheet 30 is inserted into and removed from the aperture, dust that enters the gap formed between the LCD panel 11 and the touch panel 13 or the privacy film 15 can be removed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display device comprising:
a display panel having a display surface;
a front bezel provided on a circumferential edge part of the display panel and having an aperture through which a cleaning member for removing dust adhering to the display surface can be freely inserted and removed; and
a touch panel provided on the front bezel in a manner that the touch panel is arranged to face the display surface of the display panel, with a gap formed between the display surface of the display panel and the touch panel.

2. The device according to claim 1, wherein the display panel is an LCD (liquid crystal display) panel.

3. The device according to claim 1, further comprising a privacy film which is arranged between the front bezel and the touch panel and limits an viewing angle of an image displayed on the display surface of the display panel to a specific direction.

4. The device according to claim 1, wherein the front bezel is formed in a substantially rectangular shape, and
the aperture is provided substantially linearly at least along one side of the front bezel.

5. The device according to claim 4, wherein the aperture is provided linearly with a greater length than a width of the display surface in substantially the same direction as a longitudinal direction of the aperture.

6. The device according to claim 4, wherein the aperture is provided on one side of the front bezel and on another side opposite to the one side, and the cleaning member can be inserted from one of these apertures to the other.

7. The device according to claim 6, wherein the front bezel further includes a guide part which guides the cleaning member inserted from the aperture on one side to the aperture on the other so that the cleaning member slides in contact with the display surface of the display panel.

8. The device according to claim 7, wherein the guide part is a groove provided on inner walls on two sides of the front bezel where the apertures are not provided.

9. A display device comprising:
a display panel having a display surface;
a touch panel;
a front bezel which holds the display panel and the touch panel in such a manner that the display panel and the touch panel are arranged to face each other with a gap formed between the display panel and the touch panel, and in which an aperture continuing to the gap is formed; and
a cleaning member which is inserted into and removed from the gap through the aperture and removes dust adhering to the display surface.

10. The device according to claim 9, wherein the aperture is provided on one side of the front bezel and on another side opposite to the one side, and
a width of the cleaning member in a predetermined direction is made greater than a width between sidewalls on respective sides where each aperture is provided.
